(19) United States
(12) Patent Application Publication
(10) Pub. No.: US 2015/0074511 A1
(43) Pub. Date: Mar. 12, 2015

(54) REMOTE CONTROLLING DEVICE, REMOTE CONTROLLED DEVICE AND METHOD THEREOF

(71) Applicant: Lenovo (Beijing) Co., Ltd., Beijing (CN)

(72) Inventors: Can WANG, Beijing (CN); Hui DAI, Beijing (CN)

(73) Assignee: Lenovo (Beijing) Co., Ltd., Beijing (CN)

(21) Appl. No.: 14/231,498

(22) Filed: Mar. 31, 2014

(30) Foreign Application Priority Data
Sep. 9, 2013 (CN) 201310407094.X

(51) Int. Cl. G06F 17/30

(52) U.S. Cl. CPC G06F 17/30905; G06F 17/30887
USPC 715/234

(57) ABSTRACT

A remote controlling device, a remote controlled device and a method therefor are disclosed. The remote controlling device comprises a device association unit for finding and associating a remote controlled device, a webpage load unit for loading a webpage desired to be viewed, a specific object detection unit for detecting whether there is a specific object in the viewed webpage, an object information acquisition unit for acquiring information on the specific object when the specific object detection unit detects that there is the specific object, an event acquisition unit for acquiring a specific event, and a communication unit for transmitting the acquired specific event and information on the specific object associated with the specific event to the remote controlled device so that the remote controlled device acquires data corresponding to the information from a service terminal in accordance with the information and outputs the same.

### CROSS REFERENCE TO RELATED APPLICATIONS

This application claims the benefit under 35 U.S.C. §119(a) of Chinese Patent Application No. 201310407094.X, filed on Sep. 9, 2013, the disclosure of which is incorporated by reference herein in its entirety.

### TECHNICAL FIELD

The present disclosure relates to a remote controlling device, a remote controlled device and a method therefor, and more particularly, to the remote controlling device and the remote controlled device capable of playing a web video from the remote controlling device automatically and synchronously onto the remote controlled device and the method therefor.

### BACKGROUND

For current smart devices, there is a need for mapping from one device to another one; likewise, in terms of playing video on the smart device, there is also a need for playing video from one device onto another one, such as a solution of Digital Living Network Alliance (DLNA). In the solution of DLNA, all the devices are within a home network, and the respective devices can recognize each other and interact with each other. However, a problem of the solution of DLNA is that only the video from a local device can be played onto a remote side, and cloud video streams cannot be played onto the remote side.

In fact, in addition to only capable of playing the video stored in the local device on the remote terminal, a user may desire to play the cloud video (such as web video) from one device onto another one device. For such a demand, the current solutions include a ChromeCast solution from Google and an Airplay solution from Apple. The Chromecast is a TV stick introduced by Google for inserting into a HDMI interface of TV, and via music or video played by the browser of the computer or of a smart phone; pictures and sounds can be transmitted to the large screen of TV through WiFi network. Similar to Chromecast, the solution of Apple Airplay can also rapidly and conveniently transmit contents to TV, and can further play contents such as movie, picture, music and the like through a peripheral, as long as the Airplay function is built in the respective devices. Further, in prior art, there are also other solutions with function of synchronizing video contents at cloud side by multiple terminals. However, a common problem to these solutions as described above is that they requires hardware device investment, support of a video client, support of a cloud side and the like to implement this operation, and thus the required cost is high and compatibility is low.

### SUMMARY

In view of the above situation, it is desired to provide a remote controlling device and a remote controlled device capable of automatically and synchronously playing the web video from the remote controlling device onto the remote controlled device with reduced cost and improved compatibility, and a method for the remote controlling device and the remote controlled device.

According to one aspect of the present invention, there is provided a remote controlling device comprising a device association unit (or module) configured for finding and associating a remote controlled device, a webpage load unit (or module) configured for loading a webpage desired to be viewed, a specific object detection unit (or module) configured for detecting whether there is a specific object in the viewed webpage, an object information acquisition unit (or module) configured for acquiring information on the specific object when the specific object detection unit (or module) configured detects that there is the specific object, an event acquisition unit (or module) configured for acquiring a specific event, and a communication unit (or module) configured for transmitting the acquired specific event and information on the specific object associated with the specific event to the remote controlled device so that the remote controlled device acquires from a service terminal data for output corresponding to the information in accordance with the information.

Optionally, in the device according to an embodiment of the present invention, prior to completion of the webpage load, the specific object detection unit detects whether there is the specific object in the viewed webpage, and in the case where it is detected that there is the specific object, the communication unit transmits in advance a part of the information on the specific object to the remote controlled device.

Optionally, in the device according to an embodiment of the present invention, the specific object refers to a video identification, and the information on the specific object includes play progress information and/or URL information.

Optionally, in the device according to an embodiment of the present invention, the specific event is one of an automatic triggered play event at time of completion of loading, an automatic triggered full screen play event at time of completion of loading, a play event, a full screen play event, a pause event and a changing play position event.

According to another aspect of the present invention, there is provided a remote controlled device comprising a device association unit for receiving a request for association from a remote controlling device and associating with the remote controlling device, a communication unit for receiving from the remote controlling device a specific event and information on a specific object associated with the specific event in a webpage desired to be viewed, a webpage load unit for loading the webpage desired to be viewed in accordance with the received information, and a triggering unit for triggering the specific event.

Optionally, in the device according to an embodiment of the present invention, the specific object refers to a video identification, and the information on the specific object includes play progress information and/or URL information.

Optionally, in the device according to an embodiment of the present invention, the specific event is one of an automatic triggered play event at time of completion of loading, an automatic triggered full screen play event at time of completion of loading, a play event, a full screen play event, pause event and changing play position event.

According to still another aspect of the present invention, there is provided an information processing method for a remote controlling device, comprising finding and associating a remote controlled device, loading a webpage desired to be viewed; detecting whether there is a specific object in the viewed webpage, acquiring information on the specific object when the specific object detection unit detects that there is the specific object, acquiring a specific event, and transmitting the acquired specific event and information on the specific object associated with the specific event to the remote controlled device so that the remote controlled device acquires data corresponding to the information from a service terminal in accordance with the information and outputs the same.

Optionally, in the method according to an embodiment of the present invention, prior to completion of the webpage load, it is detected whether there is the specific object in the viewed webpage, and in case where it is detected that there is the specific object, a part of information on the specific object is transmitted to the remote controlled device in advance.

Optionally, in the method according to an embodiment of the present invention, the specific object refers to a video identification, and the information on the specific object includes play progress information and/or URL information.

Optionally, in the method according to an embodiment of the present invention, the specific event is one of an automatic triggered play event at time of completion of loading, an automatic triggered full screen play event at time of completion of loading, a play event, a full screen play event, a pause event and a changing play position event.

According to still another aspect of the present invention, there is provided an information processing method for a remote controlled device, comprising receiving a request for association from a remote controlling device and associating with the remote controlling device, receiving from the remote controlling device a specific event and information on the specific object associated with the specific event in a webpage desired to be viewed, loading the webpage desired to be viewed in accordance with the received information, and triggering the specific event.

Optionally, in the method according to an embodiment of the present invention, the specific object refers to a video identification, and the information on the specific object includes play progress information and/or URL information.

Optionally, in the method according to an embodiment of the present invention, the specific event is one of an automatic triggered play event at time of completion of loading, an automatic triggered full screen play event at time of completion of loading, a play event, a full screen play event, a pause event and a changing play position event.

With the remote controlling device, the remote controlled device and the method therefor according to the embodiments of the present invention, playing video with remote control with respect to the web video can be realized without increase in extra hardware investment. In addition, webpage view at remote controlling side is viewable as it is, and if it is not desired to carry out “play to”, it can turn off this setting directly. In addition, from the current implementation, it is possible to be compatible with almost all of the web video websites.

### BRIEF DESCRIPTION OF THE DRAWINGS

FIG. 1 is a block diagram showing a configuration of a remote controlling device according to an embodiment of the present invention;

FIG. 2 is a block diagram showing a configuration of a remote controlled device according to an embodiment of the present invention;

FIG. 3 is a flowchart showing a flow of an information processing method for the remote controlling device according to an embodiment of the present invention; and

FIG. 4 is a flowchart showing a flow of an information processing method for the remote controlled device according to an embodiment of the present invention.

### DETAILED DESCRIPTION

Hereinafter, a description will be made to respective embodiments of the present invention with reference to the appended drawings. The following description with reference to drawings is provided to assist in understanding of the exemplified embodiments of the present invention defined by claims and the equivalents thereof. It is included various specific details to assist in understanding, which should only be considered as illustrative. Therefore, those skilled in art will appreciate that, various alternations and modification can be made to the embodiments described herein without departing from the scope and spirit of the present invention. Furthermore, to make the specification more clearly and briefly, detailed description regarding functions and constructions known to those skilled in the art will be omitted.

For convenience of description, a description will be made hereinafter by exemplifying a case where a web video on an Android device is played onto a browser of PC (personal computer) at a remote side. However, the present invention is not limited thereto. Those skilled in the art should understand that, the implementation of the present invention can be in that any smart device, which can browse webpage, plays the contents from another smart device with functions of browsing webpage and playing web video.

The embodiment of the present invention is characterized in that synchronous play of the web videos between devices are realized with code modification of ordinary browser at terminal device. This does not need a support from the website, and therefore, can be compatible with various video websites. In addition, since only modification to codes is involved and hardware investment is not required, the cost is low.

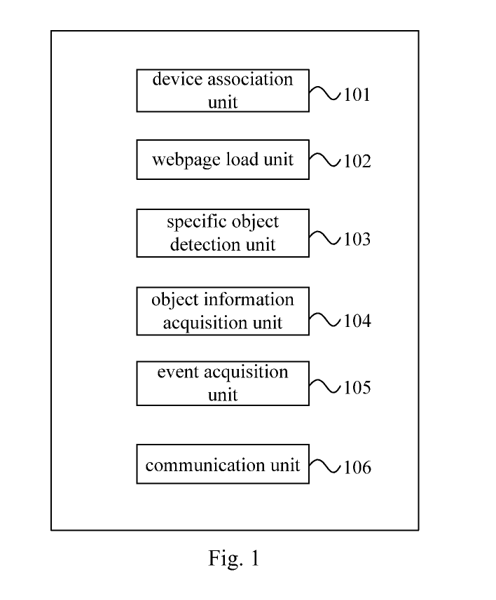

First, a remote controlling device according to an embodiment of the present invention will be described with reference to FIG. 1. Generally, the remote controlling device is a device with a display screen in a small size, such as a smart phone and the like. As shown in FIG. 1, the remote controlling device 100 comprises a device association unit (or module) 101, a webpage load unit (or module) 102, a specific object detection unit (or module) 103, an object information acquisition unit (or module) 104, an event acquisition unit (or module) 105 and a communication unit 106.

The device association unit 101 is used for finding and associating the remote controlled device. For example, the device association unit 101 finds another device with display screen in a large size (such as TV, computer and the like) and associating it as the remote controlled device. The specific content regarding the remote controlled device will be described in details hereinafter. After association is performed between the remote controlling device and the remote controlled device, it is ready to realize synchronous play of web video therebetween.

When the user desires to view a certain webpage on the remote controlling device 100, the webpage load unit 102 loads the desired webpage.

When the webpage load is completed, the specific object detection unit 103 detects whether there is a specific object in the viewed webpage. It should be explained that, the description as to the specific object detection unit 103 is a description from view point of the implementation function thereof. In practice, the above function is realized by a check unit injected into the webpage codes. In addition, for example, the specific object herein can be a video identification. Of course, the embodiment of the present invention is not limited thereto. Those skilled in art can understand that, alternatively, the specific object herein can be FLASH link identification.

If the specific object detection unit 103 detects that, there is no specific object, this means that there is no need for the content being synchronously played onto the associated remote controlled device as described hereinabove, and the process will not further proceed at this moment. On the other hand, if the specific object detection unit 103 detects that there is a specific object, this means that there is a need for the content being synchronously played onto the associated remote controlled device as described hereinabove. In that case, the object information acquisition unit 104 acquires information on the specific object. The information on the specific object can include play progress information and/or URL information.

The event acquisition unit 105 is used for acquiring a specific event. It should be explained that, the description as to the event acquisition unit 105 herein is a description from view point of implementation function thereof. In practice, the above function is realized by a monitor unit injected to the webpage codes for acquiring trigger of the specific event. For example, the specific event here can refer to an automatic triggered play event at time of completion of loading, an automatic triggered full screen play event at time of completion of loading, a play event, a full screen play event, a pause event, a changing play position event and the like.

The communication unit 106 is used for transmitting the acquired specific event and information on the specific object associated with the specific event to the remote controlled device, so that the remote controlled device acquires data corresponding to the information from a service terminal (such as cloud server or web service on other devices of the user) in accordance with the specific information and outputs the same.

If the specific event is the automatic triggered play event at time of completion of loading, this means that when the user views a webpage including the specific object at the remote controlling device, once the load is competed, there is no need for the user to further perform a play operation, and synchronous play is performed at remote controlling side and remote controlled side. At this moment, the information on the specific object associated with the load completion event refers to the play progress information and the URL information.

If the specific event is the automatic triggered full screen play event at time of completion of webpage loading, this means that once the load is competed, there is no need for the user to further perform a full screen play operation, a synchronous and full screen play is performed at remote controlling side and remote controlled side. At this moment, the information on the specific object associated with the load completion event refers to the play progress information and the URL information.

If the specific event is the play event, this means that after the load is completed, it is still necessary for the user to further perform the play operation so that the play is performed synchronously at the remote controlling side and the remote controlled side. At this moment, the information on the specific object associated with the load completion event refers to the play progress information and the URL information.

If the specific event is the full screen play event, this means that after the load is completed, it is still necessary for the user to further perform the full screen play operation so that a synchronous and full screen play is performed at the remote controlling side and the remote controlled side. At this moment, the information on the specific object associated with the load completion event refers to the play progress information and the URL information.

It should be pointed out that, all of the above exemplified specific events are events, which are prior to the synchronous play on the remote controlled device. Of course, the specific event can be an event that is further triggered on the remote controlling device after the synchronous play is performed on the remote controlled device, which is desired to be synchronously responded by the remote controlled device. The pause event and the changing play position event are such events. If the specific event is the changing play position event, the information on the specific object associated with the load completion event is the play progress information.

Described above is a general process in the case where the network speed is satisfying. However, in practice, there is often a case where the network speed is too low so that the webpage load is very low. In that case, first, at the remote controlling device, the user enters the URL information on the webpage desired to be viewed, and then the load of the webpage is performed. In the case where the network speed is low, this may take a relatively long time. After that, when synchronous play is performed on the remote controlled device, in accordance with the URL information transmitted from the remote controlling device, the webpage needs to be reloaded on the remote controlled device. That is to say, the user has to wait a double time. This greatly deteriorates user's experience.

For that case, there is a more suitable embodiment. Before the webpage load is completed, the specific object detection unit 103 detects whether there is the specific object in the viewed webpage, and in the case where it is detected that there is the specific object, the communication unit 106 transmits in advance a part of information on the specific object to the remote controlled device. In short, the information is transmitted to the remote controlled device before the completion of the webpage load at the remote controlling device side.

Particularly, in fact, it is not necessary that detection of the presence/absence of the specific object in the webpage is delayed until the whole webpage load is completed. On the contrary, when it is desired to view a webpage, an http request is first sent to a server, and then the server sends back a response including the information on the respective objects in the webpage responsive to the http request. Therefore, it can be judged at this moment whether there is the specific object in the webpage. It should be explained that, after the webpage load is completed, the progress information can not be obtained yet. To save user's time, as long as it is judged that there is the specific object in the webpage, that is, there is a possibility of synchronous play, the URL information will be transmitted to the remote controlled device in advance. In this way, the remote controlling device and the remote controlled device can load the webpage at the same time. After the webpage load is completed at the remote controlling device and the specific event is acquired, the progress information is further sent to the remote controlled device. At this moment, the webpage load has also been almost completed at the remote controlled device, and thereby the synchronous play can be realized rapidly between the remote controlling device and the remote controlled device. In this way, user's time for waiting can be effectively reduced, and thereby user's experience is improved.

In addition, it should be explained that, the specific event can be triggered on the remote controlling device in synchronous with the remote controlled device. Of course, alternatively, the remote controlling device may not trigger the specific event thereon, and simply serves as a remote controller only.

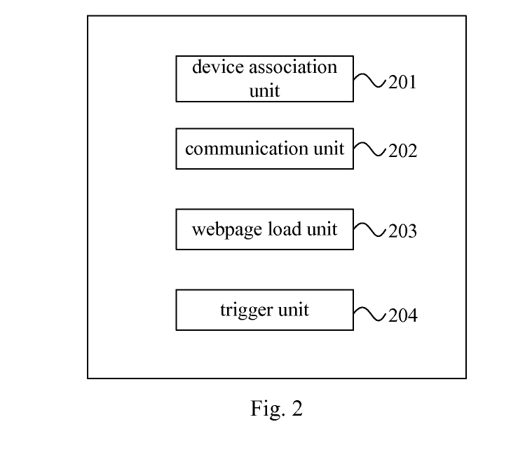

Hereinabove, the specific configurations of the remote controlling device according to the embodiment of the invention are described. Next, the remote controlled device, which serves as another side according to an embodiment of the invention, will be described. FIG. 2 shows a remote controlled device 200. Generally, the remote controlled device is a device with a display screen in a large size, such as TV, computer and the like. As shown in FIG. 2, the remote controlled device 200 includes a device association unit 201, a communication unit 202, a webpage load unit 203, and a triggering unit 204.

The device association unit 201 is used for receiving a request for association from another device severing as the remote controlling device with a display screen in a small size and for associating with the remote controlling device. As described above, after the associated is completed between the remote controlling device and the remote controlled device, it is ready to realize synchronous play of web video therebetween.

Corresponding to the communication unit 106 in the remote controlling device as described above, the communication unit 202 receives from the remote controlling device a specific event and information on the specific object associated with the specific event in a webpage desired to be viewed. As described above, for example, the specific object herein can be a video identification. Of course, the present invention is not limited thereto. Those skilled in art can understand that, alternatively, the specific object herein can be FLASH link identification.

Similar to the webpage load unit 102 in the remote controlling device 100 as described above, the webpage load unit 203 in the remote controlled device 200 loads the desired webpage in accordance with the information (URL information) received from the communication unit 202.

The triggering unit 204 is used for triggering the specific event received from the communication unit 202. As described above, for example, the specific event here can be an automatic triggered play event at time of completion of loading, an automatic triggered full screen play event at time of completion of loading, a play event, a full screen play event, a pause event, a changing play position event, and the like.

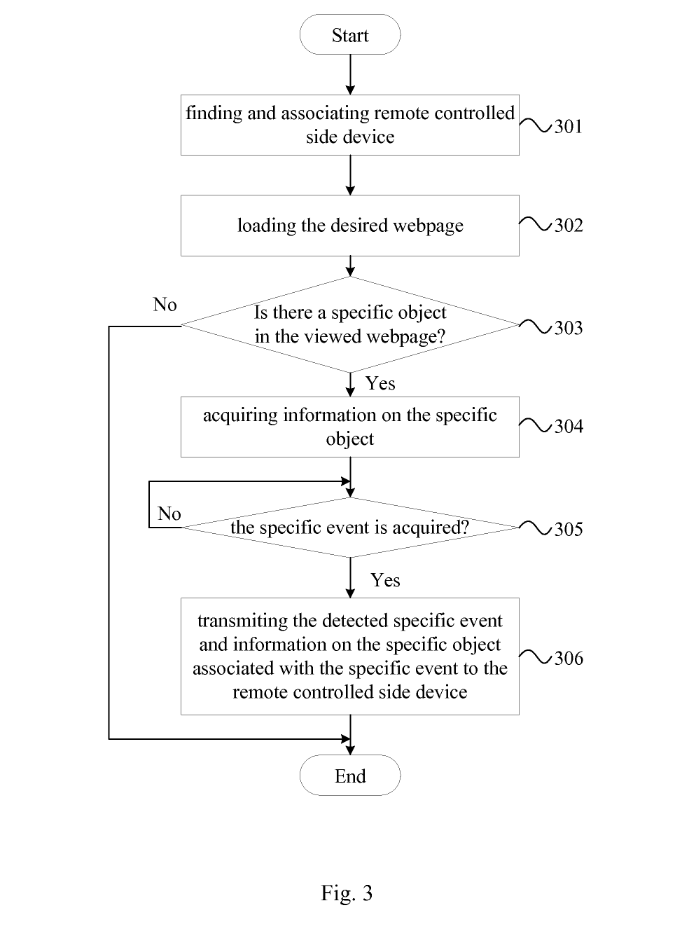

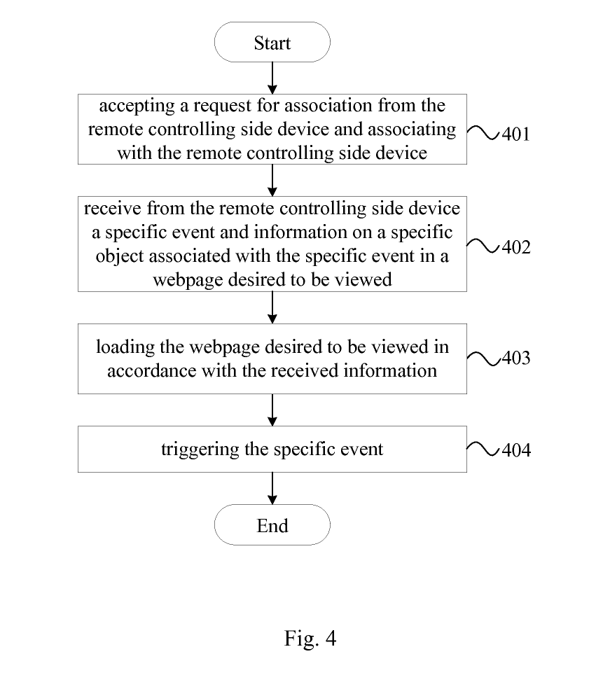

The specific configurations of the remote controlling device and the remote controlled device according to the embodiments of the present invention have been described hereinabove with reference to FIG. 1 and FIG. 2. Next, a method for the remote controlling device and the remote controlled device will be described with reference to FIG. 3 and FIG. 4.

FIG. 3 is a flowchart showing a flow of an information processing method for the remote controlling device according to an embodiment of the present invention. As shown in FIG. 3, the information processing method comprises the following steps.

First, at step S301, the remote controlled device is found and associated.

After that, at step S302, a webpage desired to be viewed is loaded.

Next, at step S303, it is detected whether there is a specific object in the viewed webpage. As described above, the above functions are realized by a check unit injected into the webpage codes. If it is detected in step S303 that there is the specific object in the viewed webpage, the process proceeds to step S304. On the other hand, if it is detected in step S303 that there is no specific object in the viewed webpage, the process is ended. As described above, the specific object can be a video identification, and the information on the specific object includes play progress and/or URL information.

At step S304, the information on the specific object is acquired.

Next, the process proceeds to step S305. At step S305, it is judged whether a specific event is acquired. As described above, this function is realized by a monitor unit injected into the webpage codes for acquiring the specific event. If it is judged at step S305 that the specific event has been acquired, the process proceeds to step S306. On the other hand, if it is detected at step S305 that the specific event has not been acquired yet, the process returns to step S305 and continues to wait. As described above, the specific event here can be an automatic triggered play event at time of completion of loading, an automatic triggered full screen play event at time of completion of loading, a play even, a full screen play event, a pause event, a changing play position event and the like.

At step S306, the detected specific event and information on the specific object associated with the specific event are transmitted to the remote controlled device, so that the remote controlled device acquires the data corresponding to the information from a service terminal (such as cloud server or web service on user's other devices) in accordance with the specific information and outputs the same.

As described above, step S303 is generally performed after the load of all the webpage is completed. However, in the case where the network speed is low, to save user's time for waiting, it is also possible to be performed before the load of all the webpage is completed. Moreover, once it is detected that there is the specific object, a part of information on the specific object is transmitted to the remote controlled device in advance.

Finally, a flow of an information processing method for the remote controlled device according to an embodiment of the present invention will be described with reference to FIG. 4. As shown in FIG. 4, the information processing method comprises the follow steps.

First, at step S401, corresponding to step S301, a request for association from the remote controlling device is received, and association with the remote controlling device is performed.

After that, at step S402, corresponding to step S306, a specific event and information on the specific object associated with the specific event in a webpage desired to be viewed are received from the remote controlling device.

Next, at step S403, the webpage desired to be viewed are loaded in accordance with the received information.

In addition, at step S404, the specific event is triggered. As described above, the specific event can be a specific event transmitted before the synchronous play is performed at the remote controlled device (such as play event), and also can be a specific event which is further triggered from the remote controlling device after the synchronous play is performed at the remote controlled device, which is desired to be further responded to by the remote controlled device (such as changing play position event).

After the synchronous play is performed at the remote controlled device, once another specific event which needs to be further responded to as described above (such as changing play position event) and the information on the specific object associated with this another specific event in the webpage desired to be viewed (such as play progress information) are received from the remote controlling device, this another specific event is triggered accordingly. Similar to the description hereinabove, the above function is realized by a synchronous unit injected into the webpage codes of remote controlled device for synchronous control operation.

Heretofore, the remote controlling device, the remote controlled device, and the method therefor according to the embodiments of the present invention have been described in details with reference to the appended drawings. Those skilled in art can understand that, with such devices and methods, a synchronous play between devices, which is compatible with almost all of the video websites, can be realized at a low cost.

Part of program codes involved in the above remote controlling device, the remote controlled device and the method therefor are listed hereinafter.

Codes for association with full screen play:

```
private void showCustomView(View view, WebChromeClient.Custom
ViewCallbackcallback) {
  // if a view already exists then immediately terminate the new one
  if (mCustomView != null) {
  callback.onCustomViewHidden( );
  return;
  }
  if (view instanceof FrameLayout)
  {
  // A video wants to be shown
  FrameLayout frameLayout = (FrameLayout) view;
  View focusedChild = frameLayout.getFocusedChild( );
      if (focusedChild instanceof VideoView)
      {
      if (mCurrentWebView != null &&
mCurrentWebView.getSettings( ).getJavaScriptEnabled( ))
  {
    sendPlayMsg(true);
  }
  }
  }
```

Example of key codes:
Example of codes for clicking “play to” (code at Android side):

```
public void sendPlayMsg(boolean bIsFullScreen){
    String js = ″javascript:(function( ){″ +
      ″var objs = document.getElementsByTagName(\″video\″);″ +
      ″if(objs.length > 0){″ +
  ″ for(var i=0;i<objs.length;i++){″ +
  ″ if(objs[i].played != undefined && objs[i].played) ″ +
  ″ {local code function (objs[i].src);}″ +
  ″ }″ +
  ″}else{″ +
  ″ local code function (\″\″);″ +
  ″}″ +
  ″}) ( )″;
    mCurrentWebView.loadUrl(js);
  }
```

Example of codes for association with web video play event (code at android side):

```
public void addVideoClickListner( ) {
  mCurrentWebView.loadUrl(″javascript:{″ +
      ″function onVideoPlay( ) {local code function(this.src);}″ +
      ″function onLoadStart( ) {local code function (this.src);}″ +
      ″var objs = document.getElementsByTagName (\″video\″);″ +
      ″for(var i=0;i<objs.length;i++) ″ +
      ″{″ +
        ″objs[i].removeEventListener(’play’,
onVideoPlay);objs[i].addEventListener(’play’, onVideoPlay);″+
  ″if(objs[i].played){ local code function(objs[i].src);}″+
      ″}″ +
    ″}″);
  }
```

It should be explained that, in the specification, the terms of “comprise”, “include” or any other equivalents thereof are intended to cover non-exclusive “inclusion”, so as to enable a procedure, method, article or device comprising series of elements not only to comprise those elements, but also to comprise other elements that are not explicitly listed or to comprise elements inherent to this procedure, method, article or device. In the case where there is no further limitation, elements defined by a recitation of “comprise . . . ” does not exclude that there additional identical elements exist in the procedure, method, article, or device comprising the elements.

Finally, it should be also explained that, the above series of processes not only include processes performed chronologically in order described herein, but also include processes performed in parallel or individually, rather than in chronological order.

With the above description of the embodiments, those skilled in the art can clearly understand that the present invention can be realized by software in combination with necessary hardware platform, and definitely can be implemented all by software. Based on this understanding, all or part of contribution of the technical solution of the present invention to the background art can be embodied in software product, and this computer software product can be stored on a storage medium such as ROM/RAM, magnetic disk, CD-ROM and the like including several instructions to enable a computer (which can be personal computer, server, network device or the like) to perform the methods described in respective embodiments or certain parts of the embodiments of the present invention.

Hereinabove, the embodiments of the present invention have been described in details, and in the specification, specific examples are employed to illustrate the principle and implementation of the embodiments and the explanation of the above embodiments are only used to assist in understanding the method and core concept of the present invention; meanwhile, to those skilled in the art, according to the concept of the present invention, changes may be made to the specific embodiments and applications. To sum up, the contents of the present specification should not be constructed as a limitation to the present invention.

What is claimed is:

1. A remote controlling device comprising:
a device association unit configured for finding and associating a remote controlled device;
a webpage load module configured for loading a webpage desired to be viewed;
a specific object detection module configured for detecting whether there is a specific object in the viewed webpage;
an object information acquisition module configured for acquiring information on the specific object when the specific object detection module detects that there is the specific object;
an event acquisition module configured for acquiring a specific event; and
a communication module configured for transmitting the acquired specific event and information on the specific object associated with the specific event to the remote controlled device so that the remote controlled device acquires from a service terminal data corresponding to the information in accordance with the information and outputs the same.

2. The device of claim 1, wherein prior to completion of the webpage load, the specific object detection module detects whether there is the specific object in the viewed webpage, and in a case where it is detected that there is the specific object, the communication module transmits in advance a part of the information on the specific object to the remote controlled device.

3. The device of claim 1, wherein the specific object refers to a video identification, and the information on the specific object includes play progress information and/or URL information.

4. The device of claim 1, wherein the specific event is one of an automatic triggered play event at time of completion of loading, an automatic triggered full screen play event at time of completion of loading, a play event, a full screen play event, a pause event and a changing play position event.

5. A remote controlled device comprising:
a device association module configured for receiving a request for association from a remote controlling device and associating with the remote controlling device;
a communication module configured for receiving from the remote controlling device a specific event and information on a specific object associated with the specific event in a webpage desired to be viewed;
a webpage load module configured for loading the webpage desired to be viewed in accordance with the received information; and
a triggering module configured for triggering the specific event.

6. The device of claim 5, wherein the specific object refers to a video identification, and the information on the specific object includes play progress information and/or URL information.

7. The device of claim 5, wherein the specific event is one of a automatic triggered play event at time of completion of loading, an automatic triggered full screen play event at time of completion of loading, a play event, a full screen play event, a pause event and a changing play position event.

8. An information processing method for a remote controlling device, comprising:
finding and associating a remote controlled device;
loading a webpage desired to be viewed;
detecting whether there is a specific object in the viewed webpage;
acquiring information on the specific object when the specific object detection module detects that there is the specific object;
acquiring a specific event; and
transmitting the acquired specific event and information on the specific object associated with the specific event to the remote controlled device so that the remote controlled device acquires data corresponding to the information from a service terminal in accordance with the information and outputs the same.

9. The method of claim 8, wherein prior to completion of the webpage load, it is detected whether there is the specific object in the viewed webpage, and in a case where it is detected that there is the specific object, a part of information on the specific object is transmitted to the remote controlled device in advance.

10. The method of claim 8, wherein the specific object refers to a video identification, and the information on the specific object includes play progress information and/or URL information.

11. The method of claim 8, wherein the specific event is one of an automatic triggered play event at time of completion of loading, an automatic triggered full screen play event at time of completion of loading, a play event, a full screen play event, a pause event and a changing play position event.
